(19) United States
(12) Patent Application Publication
(10) Pub. No.: US 2010/0189327 A1
(43) Pub. Date: Jul. 29, 2010

(54) MAGNETIC RESONANCE DEVICE AND METHOD

(75) Inventor: Miha Fuderer, Eindhoven (NL)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N. V., Eindhoven (NL)

(21) Appl. No.: 12/376,830

(22) PCT Filed: Aug. 7, 2007
(86) PCT No.: PCT/IB07/53100

§ 371 Date: Feb. 9, 2009

(30) Foreign Application Priority Data
Aug. 11, 2006 (EP) 06118788.6

(51) Int. Cl. G06K 9/00

(52) U.S. Cl. 382/131

(57) ABSTRACT

The invention relates to a device for MR imaging of a moving structure of a body (7) of a patient placed in an examination volume. The device (1) comprises means (2) for establishing a substantially homogeneous main magnetic field in the examination volume, means (3, 4, 5) for generating switched magnetic field gradients superimposed upon the main magnetic field, means (6) for radiating RF pulses towards the body (7), control means (12) for controlling the generation of the magnetic field gradients and the RF pulses, means (10) for receiving and sampling MR signals, and reconstruction means (14) for forming MR images from the signal samples. In accordance with the invention, the device (1) is arranged to a) acquire and sample MR signals from multiple image slices during a succession of motion cycles of the moving structure by subjecting at least a portion of the body (7) to at least one RF pulse and switched magnetic field gradients, b) reconstruct multiple MR slice images (a-p) from the signal samples, c) transform the set of MR slice images (a-p) into a three-dimensional image as a function of motion phase (Φ) of the moving structure by using image registration.

### FIELD OF THE INVENTION

The present invention relates to the field of magnetic resonance (MR). It finds particular application in conjunction with MR imaging methods and MR scanners for diagnostic purposes in medicine.

### BACKGROUND OF THE INVENTION

In MR imaging, pulse sequences consisting of RF pulses and switched magnetic field gradients are applied to an object (a patient) to generate magnetic resonance signals, which are scanned in order to obtain information therefrom and to reconstruct images of the object. Since its initial development, the number of clinical relevant fields of application of MRI has grown enormously. MRI can be applied to almost every part of the body, and it can be used to obtain information about a number of important functions of the human body. The pulse sequence which is applied during an MRI scan determines completely the characteristics of the reconstructed images, such as location and orientation of the image slice in the object, dimensions, resolution, signal-to-noise ratio, contrast, sensitivity for movements, etcetera. An operator of a MRI device has to choose the appropriate sequence and has to adjust and optimize its parameters for the respective application.

In the past, cardiac magnetic resonance imaging methods have been of limited clinical value for several reasons. This is because the heart as a moving object is particularly difficult to image. The breathing of the examined patient causes a periodic motion of the heart and other surrounding internal structures of the body of the examined patient. The imaging situation is further complicated by the beating motion of the heart which is added to the breathing motion. Both motions, heart motion and breathing motion, are present during the relatively long period of acquisition of MR signals.

It is known that the beating motion of the heart is fastest during systole and relatively motionless during diastole, in which the heart is fully expanded. Thus, MR images reconstruced from MR signals acquired during a diastole provide the clearest images of the heart. The breathing motion in turn can be eliminated by simply asking the examined patient to hold his or her breath during the acquisition of MR signals or by acquiring the MR signals during quiet breathing periods.

According to known methods for cardiac MR imaging, the ECG of the examined patient is monitored in order to synchronize the acquisition of MR signals with the heart cycle. The ECG signal is a repetitive pattern reflecting the electrical activity of the patients heart. Each cardiac cycle begins with a so-called R-wave (highest amplitude peak) in the ECG signal during the systole period and ends with the diastole period almost without any electrical activity. It is known to monitor the heart rate of the patient prior to the actual image acquisition and to determine a time interval between successive R-waves. This time period obtained from the heart rate monitoring is used to prospectively estimate future intervals between successive R-waves. The acquisition of MR signals can be activated correspondingly such that image data may be obtained during the relatively motionless diastole period.

From U.S. Pat. No. 6,144,200 it is known to apply an echo planar imaging (EPI) pulse sequence to cardiac imaging in order to enable the acquisition of a series of images showing the heart at different phases of its cycle in a single breath-hold. According to the known technique, MR signals are acquired continuously during a succession of cardiac cycles. Images depicting the entire cardiac cycle are retrospectively reconstructed by selecting views on the basis of the monitored ECG. Multiple phases of the cardiac cycle are visualized by repeated acquisition of the same k-space segment within each R-R interval of the ECG signal but assigning the data acquired at different time points in the cardiac cycle to different cardiac phases.

A drawback of the method known from U.S. Pat. No. 6,144,200 is that it does not sufficiently take irregularities of the motion of the heart into account. According to the known technique, the MR signals acquired at given points in time are assigned to the corresponding cardiac phases solely on the basis of the ECG signal. But irregularities of the motion of the heart do not only have an impact on duration of the heartbeat. Often, the heart also moves irregularly during single cardiac cycles. In such cases, the known method fails to collect sufficient consistent data to reconstruct an accurate representation of the motion of the heart as a function of cardiac phase. It has to be taken into account in this context that patients subjected to cardiac MR imaging often suffer from cardiovascular disease, and cardiac arrythmia is one frequent symptom of cardiovascular disease. With such patients, the known MR imaging method fails to produce images without motion artefacts.

### SUMMARY OF THE INVENTION

Therefore, it is readily appreciated that there is a need for an improved MR device and method. It is consequently the primary object of the present invention to provide a technique, which enables MR imaging of the heart or other moving structures of the body of the examined patient with enhanced image quality.

In accordance with the present invention, a device for MR imaging of a moving structure of a body of a patient placed in an examination volume is disclosed. The device comprises means for establishing a substantially homogeneous main magnetic field in the examination volume, means for generating switched magnetic field gradients superimposed upon the main magnetic field, means for radiating RF pulses towards the body, control means for controlling the generation of the magnetic field gradients and the RF pulses, means for receiving and sampling MR signals, and reconstruction means for forming MR images from the signal samples. The device is characterized in that it is arranged to
a) acquire and sample MR signals from multiple image slices during a succession of motion cycles of the moving structure by subjecting at least a portion of the body to at least one RF pulse and switched magnetic field gradients,
b) reconstruct multiple MR slice images from the signal samples,
c) transform the set of MR slice images into a three-dimensional image as a function of motion phase of the moving structure by using image registration.

The invention aims at producing a three-dimensional image as a function of motion phase, so to establish I(x,y,z,Φ), wherein x,y,z represent the spatial coordinates and Φ the motion phase (e.g., the cardiac phase). In accordance with the invention, multiple image slices are acquired continuously while the heart is beating. The MR imaging pulse sequence may run asynchronously to the cardiac cycle while the image slices repeatedly sweep over the volume of interest in which the moving heart is located. The gist of the invention is to apply image registration in order to transform the MR slice images, which are acquired as a function of time, into a three-dimensional image as a function of motion phase without creating artefacts being due to motion irregularities. An insight of the invention is that, in the event of regular motion of the imaged anatomic structure, the MR slice images acquired at equidistant points in time correspond to parallel and equidistant hyperplanes in the (x,y,z,Φ)-space. Irregularities of the motion of the anatomic structure of interest are not known beforehand. But such irregularities are reflected as noticeable deviations from the parallel and equidistant course of the acquired image data in the (x,y,z,Φ)-space. These deviations can be effectively compensated for by means of image registration in accordance with the invention. Thus, the invention significantly improves cardiac image quality by means of mere post-processing of the acquired data. Motion artefacts are reduced without an increase in acquisition time.

Registration is a fundamental task in image processing used to match two or more images taken, for example, at different times, from different sensors or from different viewpoints. Over the years, a broad range of techniques have been developed for the various types of data and problems. These techniques have been independently studied for several different applications resulting in a large body of research. In medical imaging, sets of data acquired from a patient at different points in time (or by means of different imaging modalities) will be in different coordinate systems. Generally, image registration is the process of transforming the different sets of data into one coordinate system. This is the (x,y,z,Φ)-coordinate system according to the present invention. Registration is used to correctly integrate the data acquired as a function of time in (x,y,z,Φ)-space by using a-priori knowledge pertaining to the parallel and equidistant course of the image data in the (x,y,z,Φ)-space.

In a practical embodiment of the invention, image registration is performed in step c) by relating acquired MR slice images (referred to as target images) to a set of reference images of the moving structure in different motion phases. The reference images may be provided separately, e.g., from an earlier low-resolution reference examination of the patient. Alternatively, since irregularities of the motion usually occur only as exceptions from the normal motion, image registration may be performed in step c) by relating acquired MR slice images as target images to reference images derived from other images from the same set of MR slice images by means of interpolation. It can be assumed that most of the other images do not deviate from the regular course in (x,y,z,Φ)-space along parallel and equidistant hyperplanes. This is why reference images can be derived by interpolation from all the other available MR slice images. In order to optimize image quality, the process of image registration may be performed iteratively, wherein the MR slice images are related to image data transformed during a previous iteration.

According to one embodiment of the invention, non-rigid image registration may be performed in step c). Non-rigid (or elastic) registration may be applied to cope with elastic deformations of the imaged body parts. Thus, the transformation in step c) allows local warping of image features. Non-rigid transformation include polynomial warping, interpolation of smooth basis functions (e.g., splines or wavelets), and physical continuum models. In contrast, rigid or linear transformation models are usually a combination of translation, rotation, scaling, and shear components. Linear transformations are global in nature, thus not being able to model local deformations.

The device of the invention may advantageously comprise monitoring means for monitoring the motion phase of the moving structure. A cardiac signal may be produced by the monitoring means indicating the phase of the patient's heart for each acquired MR slice image. By continuous monitoring of the ECG during image acquisition and in correspondence with the detection of R-waves in the ECG signal, the image data acquired as a function of time can be mapped to the corresponding cardiac phase Φ.

In accordance with a further development of the invention, the above-described technique can be applied to cases of composite motions of the imaged body parts. It can for example be used to transform the acquired MR slice images into a three dimensional image as a function of cardiac phase Φ and respiratory phase ψ, i.e., I(x,y,z,Φ, ψ).

The invention not only relates to a device but also to a method for MR imaging of a moving structure of a body of a patient placed in an examination volume, the method comprising the following steps:
a) acquiring and sampling MR signals from multiple image slices during a succession of motion cycles of the moving structure by subjecting at least a portion of the body to at least one RF pulse and switched magnetic field gradients,
b) reconstructing a set of multiple MR slice images from the signal samples,
c) transforming the set of MR slice images into a three-dimensional image as a function of motion phase of the moving structure by using image registration.

A computer program with instructions for carrying out the procedure of the invention can advantageously be implemented on any common computer hardware, which is presently in clinical use for the control of magnetic resonance scanners. The computer program can be provided on suitable data carriers, such as CD-ROM or diskette. Alternatively, it can also be downloaded by a user from an Internet server.

The following drawings disclose preferred embodiments of the present invention. It should be understood, however, that the drawings are designed for the purpose of illustration only and not as a definition of the limits of the invention.

### BRIEF DESCRIPTION OF THE DRAWINGS

In the drawings:

FIG. 1 shows a diagram of the imaging procedure of the invention;

FIG. 2a shows a diagram illustrating the continuous acquisition of image slices of a moving anatomic structure as a function of time according to the invention;

FIG. 2b shows a diagram schematically illustrating the course of image data as a function of motion phase in case of motion irregularities;

FIG. 2c shows a diagram schematically illustrating the image data after transformation according to the invention;

FIG. 3 shows an embodiment of an MRI scanner according to the invention.

### DETAILED DESCRIPTION OF THE EMBODIMENTS

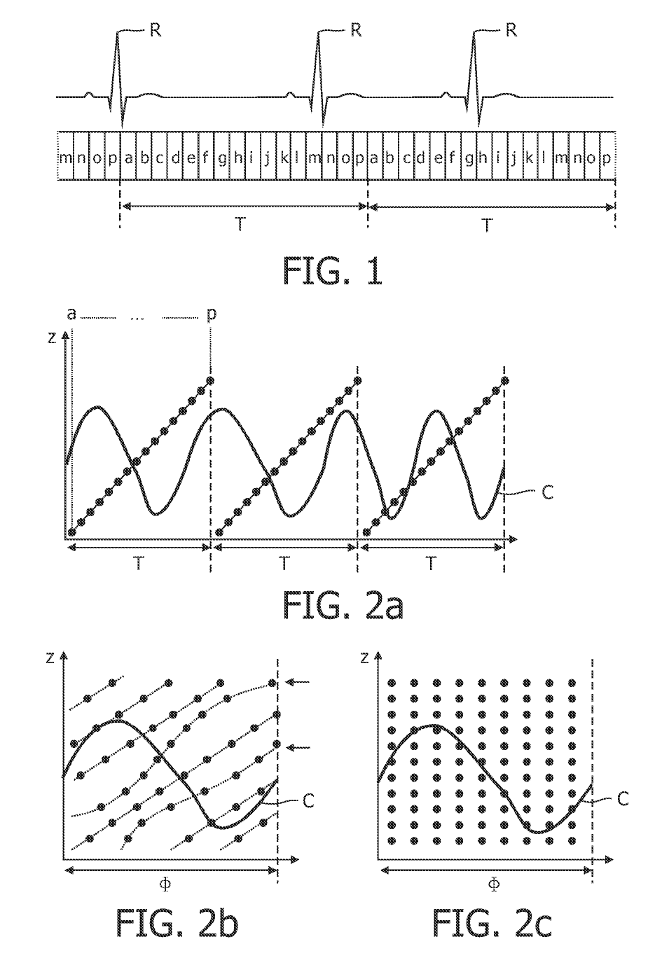

FIG. 1 illustrates the cardiac MR imaging method of the invention. The figure shows an ECG signal of a patient with three R-waves designated by R. The individual heart cycles are determined by the time intervals between successive R-waves. As can be seen in FIG. 1, the heart cycle of the examined patient changes over time. This irregularity might for example be due to the patient suffering from cardiovascular disease and cardiac arrythmia. But the motion of the patient's heart might be irregular even during each heartbeat. Such irregularities can not be deduced from the ECG signal. In accordance with the invention, the depicted ECG signal is monitored continuously during the acquisition of MR signals, and the R-waves R are detected automatically, for example by means of a computer and an appropriate program which evaluates the digitized ECG signal. MR slice images acquired according to the method of the invention are designated by the letters a-p. The letters a-p represent the cyclically repeated z-coordinates (z being the slice selection direction) of the imaged slices. The MR imaging pulse sequence runs asynchronously to the cardiac cycle while the image slices repeatedly sweep over the volume of interest in which the beating heart is located. The time T required for acquisition of the complete set of slices a-p corresponds approximately to the duration of one cardiac cycle. The sequence of RF pulses and switched magnetic field gradients used for generation of the MR signals is not shown in the figure. A well-known EPI sequence might be used. The acquisition time per slice must be short compared to the duration of the cardiac cycle, e.g., shorter than 100 ms.

FIG. 2a illustrates the continuous acquisition of image slices of a moving anatomic structure as a function of time according to the invention. The value of the z-coordinate of the acquired slices a-p continuously increases during each interval T. Each dot in the diagram represents one MR slice image. After each interval T, the acquisition starts again from the initial z-value. The solid curve C depicted in the diagrams of FIGS. 2a, 2b, and 2c symbolizes the irregular motion of the imaged anatomic structure, i.e., the heart during the repeated acquisition of MR slice images a-p. Since the MR imaging pulse sequence runs asynchronously to the cardiac cycle, a complete set of slice images is generated after several intervals T comprising slices a-p for each cardiac phase. In accordance with the invention, the separately acquired MR slice images a-p are assembled in order to generate a three-dimensional image as a function of cardiac phase Φ. This is illustrated in FIGS. 2b and 2c. Again, each dot in the diagram represents one MR slice image a-p. The time point of each individual slice measurement is mapped to the corresponding value of the cardiac phase Φ on the basis of the concurrently monitored ECG signal. The invention aims at producing a three-dimensional image I(x,y,z,Φ), wherein x,y,z represent the spatial coordinates and Φ cardiac phase. For the reason of presentability, the x- and y-coordinates are omitted in the figures. In the event of regular motion of the imaged heart, the MR slice images a-p acquired at equidistant points in time correspond to parallel and equidistant hyperplanes in the (x,y,z,Φ)-space. These hyperplanes are represented by the dotted lines in FIG. 2b. Irregularities of the motion of the anatomic structure of interest are not known beforehand. But such irregularities are reflected as noticeable deviations from the parallel and equidistant course of the acquired image data in the (x,y,z,Φ)-space. In FIG. 2b, the two curves designated by small arrows clearly deviate from the regular course. These deviations can be effectively compensated for by means of image registration in accordance with the invention. The deviations depicted in FIG. 2b are estimated and compensated for in accordance with the invention by non-rigid image registration. The MR slice image data is related to reference images derived from the other images by means of interpolation. As can be seen in FIG. 2b, most of the images do not deviate from the regular course in (x,y,z,Φ)-space along parallel and equidistant hyperplanes. This is why reference images can be derived by interpolation from all the other available MR image data. In order to optimize image quality, the process of image registration may be performed iteratively, wherein the MR slice images are related to image data transformed during a previous iteration. The result of the transformation is shown in FIG. 2c. The image data set has been ‘regridded’ such that a complete three-dimensional image is available for each value of the cardiac phase Φ. The resulting image is essentially free of motion-induced image artefacts.

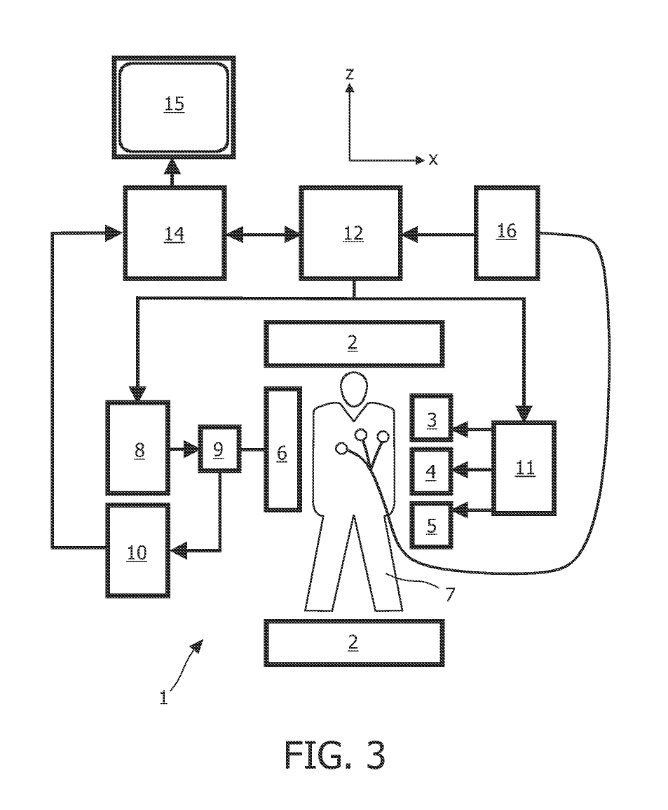

In FIG. 3, a magnetic resonance imaging device 1 is diagrammatically shown. The apparatus 1 comprises a set of main magnetic coils 2 for generating a stationary and homogeneous main magnetic field and three sets of gradient coils 3, 4 and 5 for superimposing additional magnetic fields with controllable strength and having a gradient in a selected direction. Conventionally, the direction of the main magnetic field is labelled the z-direction, the two directions perpendicular thereto the x- and y-directions. The gradient coils are energized via a power supply 11. The apparatus 1 further comprises a radiation emitter 6, an antenna or coil, for emitting radio frequency (RF) pulses to a body 7, the radiation emitter 6 being coupled to a modulator 8 for generating and modulating the RF pulses. Also provided is a receiver for receiving the MR signals, the receiver can be identical to the emitter 6 or be separate. If the emitter and receiver are physically the same antenna or coil as shown in FIG. 3, a send-receive switch 9 is arranged to separate the received signals from the pulses to be emitted. The received MR signals are input to a demodulator 10. The modulator 8, the emitter 6 and the power supply 11 for the gradient coils 3, 4 and 5 are controlled by a control system 12 to generate a sequence of RF pulses and a corresponding sequence of switched magnetic field gradients. The control system is usually a microcomputer with a memory and a program control. For the practical implementation of the invention it comprises a programming with a description of an imaging procedure according to the invention. The demodulator 10 is coupled to a data processing unit 14, for example a computer, for reconstruction of MR slice images from the acquired MR signals and for further transformation into a three-dimensional image according to the above-described technique. The final image can be made visible, for example, on a visual display unit 15. There is an ECG means 16 for monitoring the ECG of the patient 7 during acquisition of MR signals, which may be for example a standard digital ECG recording device, connected to the control system 12. The ECG means 16 in turn is connected to the patient 7 via a cable and appropriate electrodes.

1. A device for MR imaging of a periodically moving structure of a body of a patient placed in an examination volume, the device comprising
means for establishing a substantially homogeneous main magnetic field in the examination volume,
means for generating switched magnetic field gradients superimposed upon the main magnetic field,
means for radiating RF pulses towards the body,
control means for controlling the generation of the magnetic field gradients and the RF pulses,
means for receiving and sampling MR signals, and
monitoring means for monitoring the motion phase of the moving structure, and
reconstruction means for forming MR images from the signal samples, wherein the device is arranged to
a) acquire and sample MR signals from multiple image slices at equidistant points in time during a succession of motion cycles of the moving structure by subjecting at least a portion of the body to at least one RF pulse and switched magnetic field gradients,
b) reconstruct multiple MR slice images from the signal samples, and
c) transform the set of MR slice images into a three-dimensional image as a function of spatial coordinates and motion phase, wherein the time point of each slice acquisition is mapped to the corresponding value of the motion phase, and wherein irregularities of the motion of the moving structure reflected as deviations from a parallel and equidistant arrangement of the slice images space (x,y,z,Φ)-space are estimated and compensated for by using image registration.

2. The device of claim 1, wherein the device is arranged to perform image registration in step c) by relating acquired MR slice images as target images to a set of reference images of the moving structure in different motion phases of the moving structure.

3. The device of claim 2, wherein the device is further arranged to perform image registration in step c) by relating acquired MR slice images as target images to reference images derived from other images from the set of acquried MR slice images by interpolation.

4. The device of claim 1, the device being arranged to perform image registration iteratively, wherein acquired MR slice images are related to image data transformed during a previous iteration.

5. The device of claim 1, wherein the device is arranged to perform non-rigid image registration in step c).

6. (canceled)

7. The device of claim 1, wherein the monitoring means produces a cardiac signal indicating the phase of the patient's heart.

8. The device of claim 1, wherein the device is arranged to transform the MR slice images into a three-dimensional image as a function of cardiac phase and/or respiratory phase.

9. A method for MR imaging of a periodically moving structure of a body of a patient placed in an examination volume, the method comprising the following steps:
a) acquiring and sampling MR signals from multiple image slices at equidistant points in time during a succession of motion cycles of the moving structure by subjecting at least a portion of the body to at least one RF pulse and switched magnetic field gradients, the motion phase of the moving structure being monitored during signal acquisition,
b) reconstructing a set of multiple MR slice images from the signal samples,
c) transforming the set of MR slice images into a three-dimensional image as a function of spatial coordinates and motion phase of the moving structure, wherein the time point of each slice acquisition is mapped to the corresponding value of the motion phase, and wherein irregularities of the motion of the moving structure reflected as deviations from a parallel and equidistant arrangement of the slice images in (x,y,z,Φ)-space are estimated and compensated for by using image registration.

10. The method of claim 9, wherein image registration is performed in step c) by relating acquired MR slice images as target images to reference images derived from other images from the set of acquired MR slice images by interpolation.

11. (canceled)

12. A computer program for an MR device with instructions for:
a) acquiring and sampling MR signals from multiple image slices at equidistant points in time during a succession of motion cycles of a moving structure, the motion phase of the moving structure being monitored during signal acquisition,
b) reconstructing a set of multiple MR slice images from the signal samples,
c) transforming the set of MR slice images into a three-dimensional image as a function of spatial coordinates and motion phase of the moving structure, wherein the time point of each slice acquisition is mapped to the corresponding value of the motion phase, and wherein irregularities of the motion of the moving structure reflected as deviations from a parallel and equidistant arrangement of the slice images in (x,y,z,Φ)-space are estimated and compensated for by means of image registration.

13. The computer program of claim 12, comprising instructions for performing image registration iteratively, wherein MR slice images are related to image data transformed during a previous iteration.

14. (canceled)
